(19) United States
(12) Patent Application Publication
(10) Pub. No.: US 2011/0229636 A1
(43) Pub. Date: Sep. 22, 2011

(54) APPARATUS AND METHOD FOR CONTROLLING THE DEPOSITION OF GRANULES ON AN ASPHALT-COATED SHEET

(76) Inventors: David P. Aschenbeck, Newark, OH (US); Jong H. Han, New Albany, OH (US)

(21) Appl. No.: 12/725,497

(22) Filed: Mar. 17, 2010

(51) Int. Cl. B05D 3/12; B05C 11/04

(52) U.S. Cl. 427/186; 118/100

(57) ABSTRACT

An apparatus for applying granules onto an asphalt-coated sheet includes a granule applicator positioned above an asphalt-coated sheet moving in a machine direction. The granule applicator deposits granules into contact with the asphalt-coated sheet along a contact line substantially perpendicular to the machine direction, thereby defining a granule-coated sheet. A granule deflector plate engages the granule-coated sheet downstream of the contact line such that the granule deflector plate rides on the granules of the granule-coated sheet.

### TECHNICAL FIELD

This invention relates to asphalt-based roofing materials. More particularly, this invention relates to methods and apparatus for controlling the deposition of granules from a granule applicator on an asphalt-coated sheet.

### BACKGROUND OF THE INVENTION

Asphalt-based roofing materials, such as roofing shingles, roll roofing and commercial roofing, are installed on the roofs of buildings to provide protection from the elements, and to give the roof an aesthetically pleasing look. Typically, the roofing material is constructed of a substrate such as a glass fiber mat or an organic felt, an asphalt coating on the substrate, and a surface layer of granules embedded in the asphalt coating.

A common method for the manufacture of asphalt shingles is the production of a continuous sheet of asphalt material followed by a shingle cutting operation which cuts the material into individual shingles. In the production of asphalt sheet material, either a glass fiber mat or an organic felt mat is passed through a coater containing hot liquid asphalt to form a tacky, asphalt-coated sheet. Subsequently, the hot asphalt-coated sheet is passed beneath one or more granule applicators which discharge protective and decorative surface granules onto portions of the asphalt sheet material.

In the manufacture of colored shingles, two types of granules are typically employed. Headlap granules are granules of relatively low cost used for the portion of the shingle which will be covered up on the roof. Colored granules or prime granules are of relatively higher cost and are applied to the portion of the shingle that will be exposed on the roof.

To provide a color pattern of pleasing appearance, the colored portion of the shingles may be provided with areas of different colors. Usually the shingles have a background color and a series of granule deposits of different colors or different shades of the background color. A common method for manufacturing the shingles is to discharge blend drops onto spaced areas of the tacky, asphalt-coated sheet. Background granules are then discharged onto the sheet and adhere to the tacky, asphalt-coated areas of the sheet between the granule deposits formed by the blend drops. The term “blend drop,” as used herein, refers to the flow of granules of different colors or different shades of color (with respect to the background color) that is discharged from a granule blend drop applicator onto the asphalt-coated sheet. The patch or assemblage of the blend drop granules on the asphalt-coated sheet is also referred to as the “blend drop.”

### SUMMARY OF THE INVENTION

The present application describes various embodiments of apparatus and methods for applying granules onto an asphalt-coated sheet. One embodiment of the apparatus for applying granules onto an asphalt-coated sheet includes a granule applicator positioned above an asphalt-coated sheet moving in a machine direction. The granule applicator deposits granules into contact with the asphalt-coated sheet along a contact line substantially perpendicular to the machine direction, thereby defining a granule-coated sheet. A granule deflector plate engages the granule-coated sheet downstream of the contact line such that the granule deflector plate rides on the granules of the granule-coated sheet.

In another embodiment, an apparatus for applying granules onto an asphalt-coated sheet includes a granule applicator positioned above an asphalt-coated sheet moving in a machine direction. The granule applicator deposits granules into contact with the asphalt-coated sheet along a contact line substantially perpendicular to the machine direction, thereby defining a granule-coated sheet. A granule deflector plate includes a deflector portion and engages the granule-coated sheet downstream of the contact line. The granule deflector plate is positioned such that granules which bounce from the contact line forwardly in the machine direction are deflected into the granule-coated sheet by the deflector portion.

One embodiment of a method of applying granules onto an asphalt-coated sheet includes depositing granules from a granule applicator into contact with an asphalt-coated sheet moving in a machine direction. The granules are deposited along a contact line substantially perpendicular to the machine direction, thereby defining a granule-coated sheet. A granule deflector plate is positioned into engagement with the granule-coated sheet downstream of the contact line such that the granule deflector plate rides on the granules of the granule-coated sheet.

Other advantages of the apparatus and methods for applying granules onto an asphalt-coated sheet will become apparent to those skilled in the art from the following detailed description, when read in light of the accompanying drawings.

### BRIEF DESCRIPTION OF THE DRAWINGS

FIG. 1 is a schematic view in elevation of a known apparatus for manufacturing an asphalt-based roofing material.

FIG. 2 is an enlarged schematic view of the background granule applicator illustrated in FIG. 1.

FIG. 3 is an enlarged schematic view of the background granule applicator, showing a first embodiment of a granule deflector assembly according to the invention.

FIG. 3A is an enlarged schematic view of a portion of the granule deflector assembly illustrated in FIG. 3.

FIG. 4. is an enlarged schematic view of the background granule applicator illustrated in FIG. 3, showing the granule deflector assembly in alternate positions.

FIG. 5 is an enlarged schematic view of a second embodiment of the granule deflector assembly.

FIG. 6 is an enlarged schematic view of a third embodiment of the granule deflector assembly.

FIG. 7 is an enlarged schematic view of a fourth embodiment of the granule deflector assembly.

FIG. 8 is an enlarged schematic view of a fifth embodiment of the granule deflector assembly.

FIG. 9 is an enlarged schematic view of a sixth embodiment of the granule deflector assembly.

FIG. 10 is an enlarged schematic plan view of a portion of an asphalt-coated sheet and the first embodiment of the granule deflector assembly illustrated in FIG. 3.

FIG. 11 is an enlarged schematic plan view of a portion of an asphalt-coated sheet and a seventh embodiment of the granule deflector assembly.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The term “asphalt coating” means any type of bituminous material suitable for use on a roofing material, such as asphalts, tars, pitches, or mixtures thereof. The asphalt can be either manufactured asphalt produced by refining petroleum or naturally occurring asphalt. The asphalt coating can include various additives and/or modifiers, such as inorganic fillers or mineral stabilizers, organic materials such as polymers, recycled streams, or ground tire rubber. Preferably, the asphalt coating contains asphalt and an inorganic filler or mineral stabilizer.

Composite shingles, such as asphalt shingles, are a commonly used roofing product. Asphalt shingle production generally includes feeding a base material from an upstream roll and coating it first with a roofing asphalt material, then a layer of granules. The base material is typically made from a fiberglass mat provided in a continuous shingle membrane or sheet. It should be understood that the base material can be any suitable support material.

Composite shingles may have a headlap region and a prime region. The headlap region may be ultimately covered by adjacent shingles when installed upon a roof. The prime region will be ultimately visible when the shingles are installed upon a roof.

The granules deposited on the composite material shield the roofing asphalt material from direct sunlight, offer resistance to fire, and provide texture and color to the shingle. The granules generally involve at least two different types of granules. Headlap granules are applied to the headlap region. Headlap granules are relatively low in cost and primarily serve the functional purposes of covering the underlying asphalt material for a consistent shingle construction, balancing sheet weight, and preventing overlapping shingles from sticking to one another. Colored granules or other prime granules are relatively expensive and are applied to the shingle at the prime regions. Prime granules are disposed upon the asphalt strip for both the functional purpose of protecting the underlying asphalt strip and for the purpose of providing an aesthetically pleasing appearance of the roof.

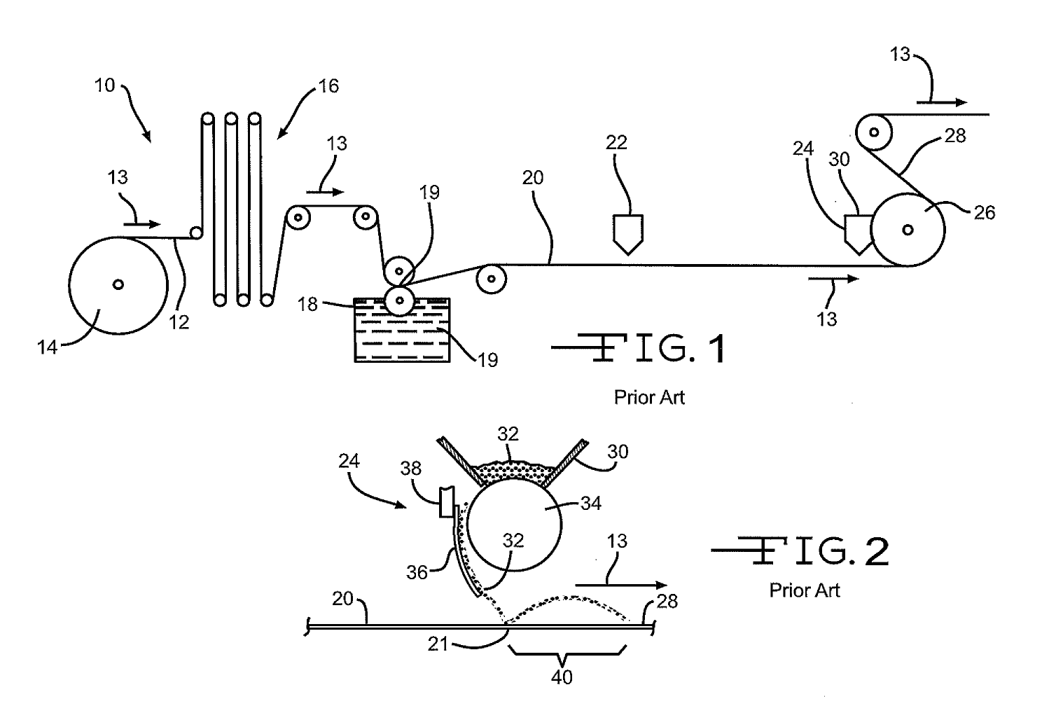

Referring now to the drawings, there is shown in FIG. 1 a known apparatus 10 for manufacturing an asphalt-based roofing material, and more particularly for applying granules onto an asphalt-coated sheet. The illustrated manufacturing process involves passing a continuous sheet of substrate or shingle mat 12 in a machine direction 13 through a series of manufacturing operations. The sheet usually moves at a speed of at least about 200 feet/minute (61 meters/minute), and typically at a speed within the range of between about 450 feet/minute (137 meters/minute) and about 800 feet/minute (244 meters/minute). However, other speeds may be used.

In a first step of the manufacturing process, the continuous sheet of shingle mat 12 is payed out from a roll 14. The shingle mat 12 may be any type known for use in reinforcing asphalt-based roofing materials, such as a nonwoven web of glass fibers. Alternatively, the substrate may be a scrim or felt of fibrous materials such as mineral fibers, cellulose fibers, rag fibers, mixtures of mineral and synthetic fibers, or the like.

The sheet of shingle mat 12 is passed from the roll 14 through an accumulator 16. The accumulator 16 allows time for splicing one roll 14 of substrate to another, during which time the shingle mat 12 within the accumulator 16 is fed to the manufacturing process so that the splicing does not interrupt manufacturing.

Next, the shingle mat 12 is passed through a coater 18 where a coating of asphalt 19 is applied to the shingle mat 12 to form an asphalt-coated sheet 20. The asphalt coating 19 may be applied in any suitable manner. In the illustrated embodiment, the shingle mat 12 contacts a supply of hot, melted asphalt 19 to completely cover the shingle mat 12 with a tacky coating of asphalt 19. However, in other embodiments, the asphalt coating 19 could be sprayed on, rolled on, or applied to the shingle mat 12 by other means. Typically the asphalt coating is highly filled with a ground mineral filler material, amounting to at least about 60 percent by weight of the asphalt/filler combination, in some embodiments. In one embodiment, the asphalt coating 19 has a temperature in a range from about 350° F. to about 400° F. In another embodiment, the asphalt coating 19 may be at a temperature more than about 400° F. or less than about 350° F. The shingle mat 12 exits the coater 18 as an asphalt-coated sheet 20. The asphalt coating 19 on the asphalt-coated sheet 20 remains hot.

The asphalt-coated sheet 20 is passed beneath a first granule applicator. In the illustrated embodiment, the granule applicator is a blend drop applicator indicated generally at 22, where blend drop granules are applied to the asphalt-coated sheet 20. Although only one blend drop applicator 22 is shown, it will be understood that several blend drop applicators may be used. Also, the blend drop applicator 22 may be adapted to supply several streams of blend drops, or blend drops of different colors, shading, or size.

The asphalt-coated sheet 20 is then passed beneath a second granule applicator. In the illustrated embodiment, the granule applicator is a background granule applicator 24, for applying background granules 32 onto the asphalt-coated sheet 20. The background granules 32 adhere to the portions of the asphalt-coated sheet 20 that are not already covered by the blend drop granules. The background granules 32 are applied to the extent that the asphalt-coated sheet 20 becomes completely covered with granules, thereby defining a granule-coated sheet 28. The granule-coated sheet 28 is then turned around a slate drum 26 to press the granules into the asphalt coating and to temporarily invert the sheet 28. Such inverting of the granule-coated sheet 28 causes any excess granules 32 to drop off the granule-coated sheet 28 on the backside of the slate drum 26. The excess granules are collected by a hopper 30 of the background granule applicator 24. As described below, the hopper 30 is positioned on the backside of the slate drum 26. The granule-coated sheet 28 is then cooled, cut and packaged in any suitable manner, not shown. The cooling cutting and packaging operations are well known in the art.

A portion of and exemplary asphalt-coated sheet 20 is shown in FIG. 10. As shown, the asphalt-coated sheet 20 may be used in an apparatus 10 for forming multiple shingles. For example, the asphalt-coated sheet 20 may be used in an apparatus 10 for forming a plurality of shingles, such as two, three, or four shingles. The background granules 32 may include granules of different colors and/or types, such as headlap granules and prime granules, as described in detail above. In a four-wide apparatus, the asphalt-coated sheet 20 includes eight different lanes, only four of which are illustrated. In the embodiment of the asphalt-coated sheet 20 illustrated in FIGS. 10 and 11, two headlap granule lanes H1 and H2, and two prime granule lanes P1 and P2 are shown.

An interface line 48 extends in the machine direction and defines a boundary between two granule lanes having a different color and/or type of granule. In the illustrated embodiments, the interface line 48 is defined between adjacent headlap granule lanes and prime granule lanes, such as between the headlap granule lane H1 and the prime granule lane P1.

An exemplary roofing shingle that may be formed from the asphalt-coated sheet 20 is shown by a phantom line 42 in FIG. 10. The shingle 42 may be cut from the asphalt-coated sheet 20 as shown. In this manner, four roofing shingles of any desired length may be cut from each such section of the asphalt-coated sheet 20. Each shingle 42 would be cut from one headlap granule lane H1 or H2, and one respective adjacent prime granule lane P1 or P2. Accordingly, the shingle 42 includes a headlap portion 44 comprising headlap granules, and a prime or butt portion 46 comprising prime granules.

Referring now to FIG. 2, a known embodiment of the background granule applicator 24 is shown. The background granule applicator 24 includes a hopper 30. The hopper 30 is structured and configured to include compartments (not shown) which separate the headlap granules from the prime granules. The background granules 32 are fed from the hopper 30 by a fluted roll 34 from which, upon rotation, the granules 32 are discharged into contact with a chute 36. The illustrated chute 36 is elongated and has a substantially curved cross-sectional shape. Alternatively, the chute 36 may have any other desired cross-sectional shape. The chute 36 guides the background granules 32 forwardly, in the direction of the arrow 13 as the granules 32 move downwardly away from the hopper 30. As granules 32 exit the chute 36, the granules 32 define a substantially linear curtain of the granules 32 which engage the asphalt-coated sheet 20 along an impact or contact line 21, substantially perpendicular to the machine direction, as best shown in FIGS. 2, 10, and 11. The fluted roll 34 may be driven by a drive motor (not shown).

The chute 36 directs the granules 32 onto the asphalt-coated sheet 20, such that the headlap granules are deposited into the headlap granule lane H1 and H2, and the prime granules are deposited into the prime granule lane P1 and P2. If desired, the chute 36 may be provided with side walls (not shown) to maintain separation of headlap and prime granules, such that the headlap and prime granules are deposited in their respective granule lanes H1, H2, P1, and P2, relative to the asphalt-coated sheet 20. The chute 36 may be mounted to the apparatus 10 by any desired means, such as a mounting bracket 38.

When deposited onto the asphalt-coated sheet 20, some granules 32 will engage the asphalt-coated sheet 20 and become embedded in the asphalt 19. At relatively high machine speeds however, some granules 32 are known to engage other embedded granules 32, and bounce upwardly and forwardly in the direction of the arrow 13, as best shown at 40 in FIG. 2. These granules 32 either become embedded in the asphalt-coated sheet 20 as the asphalt-coated sheet 20 is turned around the slate drum 26, or become excess granules which are dropped off the granule-coated sheet 28 on the backside of the slate drum 26. Such excess granules are collected in portion of the hopper 30 with other of the same color and/or type of granule 32, i.e., headlap granules with headlap granules and prime granules with prime granules.

Some granules 32 however, are known to engage other embedded granules 32, and bounce upwardly and substantially laterally as well as forwardly. Such granules 32 which have bounced upwardly and substantially laterally may become undesirably embedded in the asphalt-coated sheet 20 with granules of another color and/or type in an adjacent lane. For example, headlap granules may become embedded in the prime granule lane P1 or P2, and prime granules may become embedded in the headlap granule lane H1 or H2. Further, as the asphalt-coated sheet 20 is turned around the slate drum 26, such granules 32 which have bounced upwardly and substantially laterally may become excess granules which are then collected in a portion of the hopper 30 with granules not of the same color and/or type. For example, headlap granules intended for the headlap granule lane H1 may bounce laterally across the interface line 48 and become mixed with prime granules in the prime granule lane P1. The mixing of granules that occurs when headlap granules cross the interface line 48 and become mixed with the prime granules in a prime granule lane, creates an esthetically undesirable appearance in the prime portion 46 of a shingle, such as the exemplary shingle 42. It will be understood that at relatively slower machine speeds, such bouncing of granules 32 is significantly minimized or eliminated.

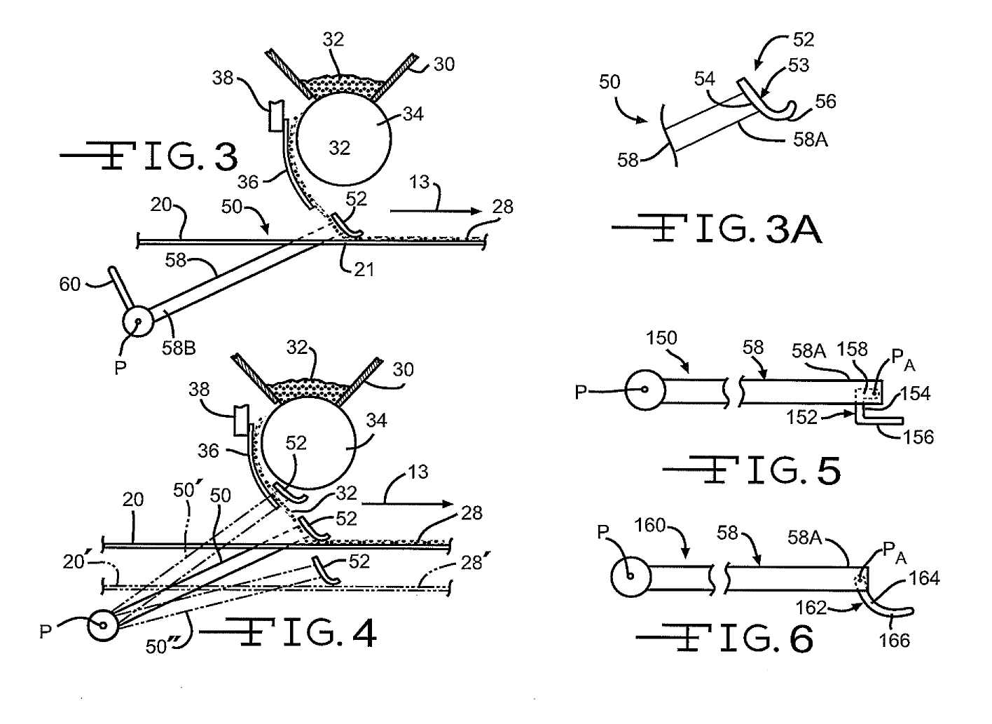

Referring now to FIGS. 3 and 3A, a first embodiment of a granule deflector assembly according to the invention is shown at 50. The granule deflector assembly 50 includes a granule deflector plate 52. The granule deflector plate 52 includes an elongated body 53 having a first or deflector portion 54 and a second or granule engagement portion 56. The deflector portion 54 defines a granule barrier, as described below. In the illustrated embodiment, the granule deflector plate 56 has a substantially J-shaped cross-section.

The granule deflector plate 52 is attached to a first end 58A of a mounting arm 58. The granule deflector assembly 50 and its attached granule deflector plate 52 may be moveably mounted relative to the apparatus 10. In the illustrated embodiment, a second end 58B of the mounting arm 58 is pivotally mounted to a portion (not shown) of the apparatus 10 about a pivot axis P. If desired, the granule deflector assembly 50 may include a pivot handle 60 for manually moving the granule deflector assembly 50 between a storage position, as described below, and an engaged position, as shown in FIG. 3.

The second end 58B of the mounting arm 58 is pivotally mounted to the apparatus 10 such that the granule engagement portion 56 of the granule deflector plate 52 rests on the asphalt-coated sheet 20. In the illustrated embodiment, the deflector portion 54 is positioned downstream of the contact line 21. The deflector portion 54 may be positioned downstream of the contact line 21 any desired distance, such as within the range of from about ¼ inch to about one inch. It will be understood however, that the deflector portion 54 may be positioned downstream of the contact line 21 any other desired distance.

The illustrated granule deflector plate 52 is formed of any desired metal and coated with heavy chrome. Alternatively, the granule deflector plate 52 may be formed from and/or coated with any other desired material with low friction and high wear properties, such as other hard metals or ceramics.

When the apparatus 10 is moving at a relatively slower machine speed such that bouncing of the granules 32 is significantly minimized, the granule deflector assembly 50 may be moved to a storage position, as shown at 50′ in FIG. 4. For example, an apparatus operator may move the handle 60 in a counterclockwise direction, thereby pivoting the mounting arm 58 and moving the granule deflector plate 52 upwardly and rearwardly such that the granule deflector plate 52 is positioned between the fluted roll 34 and the chute 36. It will be understood that when the granule deflector plate 52 is in the storage position 50′, the granules 32 may continue to move freely along the chute 36 and into contact with the asphalt-coated sheet 20.

When the granule deflector assembly 50 is in the engaged position, as shown in FIG. 3, the granule engagement portion 56 of the granule deflector plate 52 rides on the granules of the granule-coated sheet 28. Any granules 32 which contact the asphalt-coated sheet 20 and would otherwise bounce forwardly or laterally, will instead engage the deflector portion 54. The deflector portion 54 therefore functions as a granule barrier, wherein granules that engage the deflector portion 54 will be deflected and directed downwardly into contact with the granule-coated sheet 28. Immediately after engaging the deflector portion 54, the granules 32 are urged into contact with the granule-coated sheet 28 by the granule engagement portion 56 of the granule deflector plate 52.

In the illustrated embodiment, the granule deflector plate 52 has sufficient mass such that it will rest upon the asphalt-coated sheet 20 when the asphalt-coated sheet 20 is moving at relatively high machine speeds, but has sufficiently low inertia such that the granule deflector plate 52 will not damage the asphalt-coated sheet 20.

It is known that during operation of an apparatus 10 for manufacturing an asphalt-based roofing material, the asphalt-coated sheet 20 (and the downstream portion identified as the granule-coated sheet 28) may move vertically relative to the apparatus 10 (upwardly and/or downwardly when viewing FIG. 4). The granule deflector plate 52 further has sufficient mass such that it will continue to rest upon the asphalt-coated sheet 20 when the asphalt-coated sheet 20 moves vertically during normal operation of the apparatus 10. As shown by phantom line in FIG. 4, the granule deflector assembly 50″ is shown on the asphalt-coated sheet 20′ and granule-coated sheet 28′ in such a vertically downward position.

It will be understood that the granule deflector assembly 50 will continue to rest upon the asphalt-coated sheet 20 when the asphalt-coated sheet 20 is at any vertical position that may occur during normal operation of the apparatus 10. For example, as the asphalt-coated sheet 20 moves vertically relative to the apparatus 10, the pivoting mounting arm 58 of the deflector assembly 50 allows the granule deflector plate 52 to remain in the engaged position. The mounting arm 58 pivots with the vertical movement of the asphalt-coated sheet 20, ensuring that the granule engagement portion 56 of the granule deflector plate 52 remains in contact with the granule-coated sheet 28 during all such vertical movement, and ensuring that the deflector portion 54 maintains its downstream position relative to the contact line 21, as described above.

Referring now to FIG. 5, a portion of a second embodiment of the granule deflector assembly is shown at 150. The granule deflector assembly 150 includes a granule deflector plate 152 attached to a first end 58A of the mounting arm 58. The granule deflector plate 152 has a deflector portion 154 and a granule engagement portion 156. In the illustrated embodiment, the granule deflector plate 156 is an elongated member having a substantially L-shaped cross-section. A pivot member 158 extends outwardly of the deflector portion 154 (to the right when viewing FIG. 5) and is attached to the first end 58A of the mounting arm 58 about a pivot axis P_{A}, such that the granule deflector plate 152 pivots relative to the mounting arm 58.

Referring now to FIG. 6, a portion of third embodiment of the granule deflector assembly is shown at 160. The granule deflector assembly 160 includes a granule deflector plate 162 attached to a first end 58A of the mounting arm 58. In the illustrated embodiment, the granule deflector plate 166 is an elongated member having a curved cross-sectional shape and defining a deflector portion 164 and a granule engagement portion 166. The deflector portion 164 of the granule deflector plate 166 is attached to the first end 58A of the mounting arm 58 about a pivot axis P_{A}.

Referring now to FIG. 7, a portion of fourth embodiment of the granule deflector assembly is shown at 170. The granule deflector assembly 170 includes a granule deflector roller or drum 172 attached to a first end 58A of the mounting arm 58. The granule deflector drum 172 is substantially cylindrical and is attached to the first end 58A of the mounting arm 58 about a pivot axis P_{A}.

Referring now to FIG. 8, a portion of fifth embodiment of the granule deflector assembly is shown at 180. The granule deflector assembly 180 includes a granule deflector plate 182 attached to a first end 58A of the mounting arm 58. The granule deflector plate 182 is substantially identical to the granule deflector plate 52 and has a deflector portion 184 and a granule engagement portion 186. An elongated extension member 188 has a substantially flat first leg 188A and a second leg 188B extending outwardly and at an angle from the first leg 188A (upwardly and to the left when viewing FIG. 8). In the illustrated embodiment, the second leg 188B of the extension member 188 is pivotally attached to the granule engagement portion 186 of the granule deflector plate 182 about a pivot axis P_{B}.

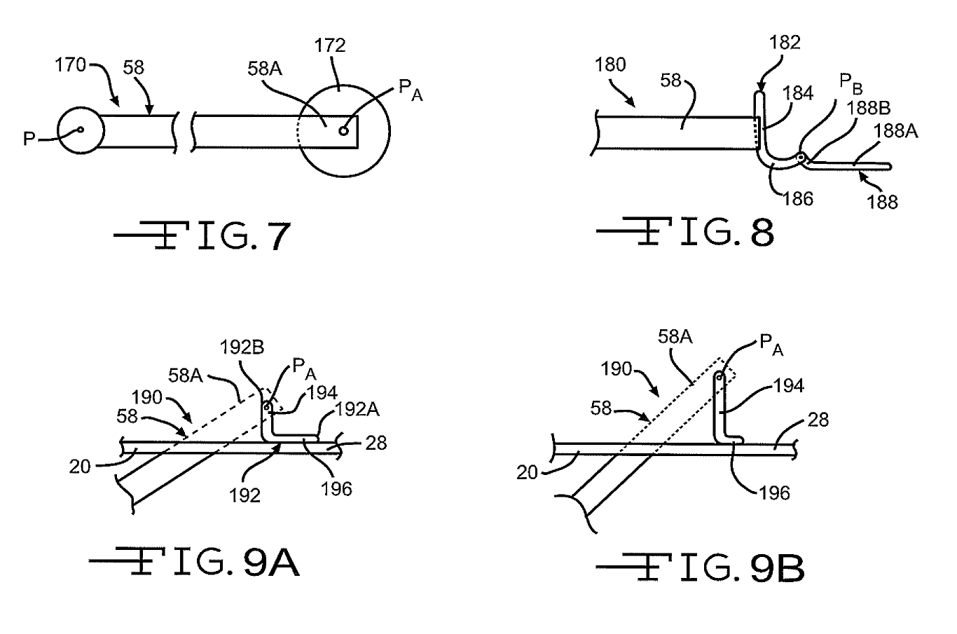

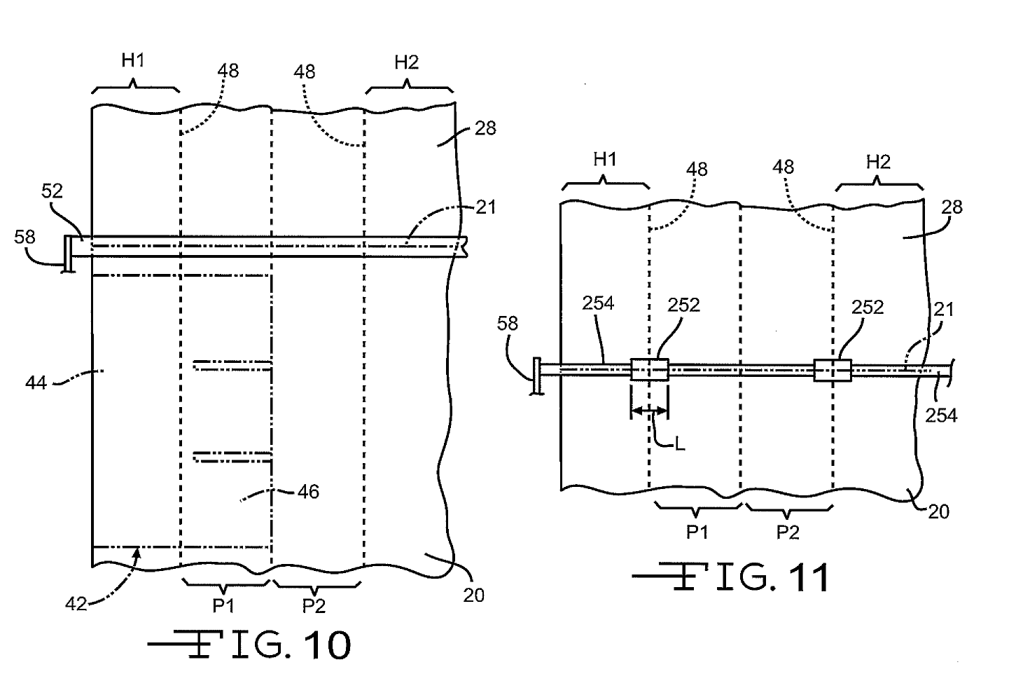

Referring now to FIGS. 9A and 9B, a sixth embodiment of the granule deflector assembly is shown at 190. The granule deflector assembly 190 includes a granule deflector plate 192 attached to a first end 58A of the mounting arm 58. The illustrated granule deflector plate 192 is formed of a substantially flexible material, such as silicon rubber. Alternatively, other substantially flexible materials may be used. The granule deflector plate 192 has a first or trailing end 192A and a second end 192B attached to a first end 58A of the mounting arm 58. When in the engaged position as shown in FIG. 9A, the granule deflector plate 192 is bent to define a deflector portion 194 and a granule engagement portion 196. If desired, second end 192B of the granule deflector plate 192 may be pivotally attached to the first end 58A of the mounting arm 58 about a pivot axis P_{A}. Because the granule deflector plate 192 is substantially flexible, the relative lengths of the deflector portion 194 and the granule engagement portion 196 may change as the relative distance between the first end 58A of the mounting arm 58 and the granule coated sheet 20 changes, as shown in FIG. 9B.

It will be understood that the granule deflector plates 152, 162, and 182, and the granule deflector drum 172, like the granule deflector plate 52, may be formed of heavy chrome. Alternatively, the granule deflector plates 152, 162, and 182, and the granule deflector drum 172 may be formed from any other suitable material with low friction and high wear properties, such as other hard metals.

Referring now to FIG. 10, any of the granule deflector plates described herein, such as the granule deflector plate 52, may extend laterally, or substantially perpendicularly, to the machine direction, across the entire width of the granule-coated sheet 28 between two mounting arms 58, only one of which is shown in FIG. 10.

Alternatively, the granule deflector plate may be formed as a plurality of deflector plate members 252. As shown in FIG. 11, the deflector plate members 252 may be positioned such that they engage the granule-coated sheet 28 and straddle each interface line 48. In the illustrated embodiment, the deflector plate members 252 are positioned such that they substantially bisect each interface line 48. In the illustrated embodiment, the deflector plate members 252 are connected by a connecting member 254 which extends between two mounting arms 58, only one of which is shown in FIG. 11. The deflector plate members 252 may have a deflector portion and a granule engagement portion, and further have any of the cross-sectional shapes described herein, such as the substantially J-shaped cross-section of the granule deflector plate 52. The deflector plate members 252 may have any desired length L, such as about two inches such that at least one inch of the member 254 extends into each of the adjacent headlap and prime granule lanes on opposite sides of the interface line 48.

The principle and mode of operation of the apparatus for applying granules onto an asphalt-coated sheet have been described in its preferred embodiment. However, it should be noted that the apparatus for applying granules onto an asphalt-coated sheet described herein may be practiced otherwise than as specifically illustrated and described without departing from its scope.

What is claimed is:

1. An apparatus for applying granules onto an asphalt-coated sheet, the apparatus comprising:
a granule applicator positioned above an asphalt-coated sheet moving in a machine direction, the granule applicator depositing granules into contact with the asphalt-coated sheet along a contact line substantially perpendicular to the machine direction, thereby defining a granule-coated sheet; and
a granule deflector plate engaging the granule-coated sheet downstream of the contact line such that the granule deflector plate rides on the granules of the granule-coated sheet.

2. The apparatus according to claim 1, wherein the granule-coated sheet has at least one interface line extending in the machine direction, the interface line defining a boundary between two granule lanes, each lane comprising a different type of granule.

3. The apparatus according to claim 2, wherein the granule deflector plate comprises a plurality of deflector plate members, each deflector plate member engaging the granule-coated sheet at an interface line.

4. The apparatus according to claim 3, wherein each deflector plate includes a body having a deflector portion and a granule engagement portion.

5. The apparatus according to claim 1, wherein the granule deflector plate is further structured and configured to urge granules deposited by the granule applicator into contact with the asphalt-coated sheet.

6. The apparatus according to claim 1, wherein the granule deflector plate is moveably mounted relative to the asphalt-coated sheet.

7. The apparatus according to claim 1, wherein the granule deflector plate includes an elongated body having a deflector portion and a granule engagement portion.

8. The apparatus according to claim 7, wherein the granule deflector plate has a substantially J-shaped cross-section.

9. The apparatus according to claim 1, wherein the granule applicator is a background granule applicator.

10. An apparatus for applying granules onto an asphalt-coated sheet, the apparatus comprising:
a granule applicator positioned above an asphalt-coated sheet moving in a machine direction, the granule applicator depositing granules into contact with the asphalt-coated sheet along a contact line substantially perpendicular to the machine direction, thereby defining a granule-coated sheet; and
a granule deflector plate engaging the granule-coated sheet downstream of the contact line;
wherein the granule deflector plate includes a deflector portion; and
wherein the granule deflector plate is positioned such that granules which bounce from the contact line forwardly in the machine direction are deflected into the granule-coated sheet by the deflector portion.

11. The apparatus according to claim 10, wherein the granule-coated sheet has at least one interface line extending in the machine direction, the interface line defining a boundary between two granule lanes, each lane comprising a different type of granule.

12. The apparatus according to claim 11, wherein the granule deflector plate comprises a plurality of deflector portions, each portion engaging the granule-coated sheet at an interface line.

13. The apparatus according to claim 10, wherein the granule deflector plate is structured and configured to ride on the granules of the granule-coated sheet, and further structured and configured to urge granules deposited by the granule applicator into contact with the asphalt-coated sheet.

14. The apparatus according to claim 10, wherein the granule deflector plate is moveably mounted relative to the asphalt-coated sheet, thereby enabling the granule deflector plate to be moved between an engaged position wherein the granule deflector plate rides on the granules of the granule-coated sheet, and a storage position wherein the granule deflector plate is no longer in contact with the granule-coated sheet.

15. The apparatus according to claim 14, wherein the granule deflector plate is moveably mounted relative to the asphalt-coated sheet, thereby further allowing the granule deflector plate to remain in the engaged position during any vertical movement of the asphalt-coated sheet 20 relative to the apparatus.

16. The apparatus according to claim 10, wherein the granule deflector plate includes an elongated body having a deflector portion and a granule engagement portion.

17. A method of applying granules onto an asphalt-coated sheet, the method comprising:
depositing granules from a granule applicator into contact with an asphalt-coated sheet moving in a machine direction, wherein the granules are deposited along a contact line substantially perpendicular to the machine direction, thereby defining a granule-coated sheet; and
positioning a granule deflector plate into engagement with the granule-coated sheet downstream of the contact line such that the granule deflector plate rides on the granules of the granule-coated sheet.

18. The method according to claim 17, wherein the granule-coated sheet has at least one interface line extending in the machine direction, the interface line defining a boundary between two granule lanes, each lane comprising a different type of granule.

19. The method according to claim 17, further including urging the granules deposited by the granule applicator into contact with the asphalt-coated sheet with the granule deflector plate.

20. The method according to claim 17, wherein the granule deflector plate includes an elongated body having a deflector portion and a granule engagement portion.
